(19) United States
(12) Patent Application Publication
(10) Pub. No.: US 2007/0039968 A1
(43) Pub. Date: Feb. 22, 2007

(54) Seal assembly for ultrahigh-pressure vessels

(75) Inventors: Edmund Y. Ting, Kent, WA (US); Niclas Engstrom, Kent, WA (US); David O. Monserud, Seattle, WA (US)

Correspondence Address: HARNESS, DICKEY & PIERCE, P.L.C., P.O. BOX 8910, RESTON, VA, 20195, US

(73) Assignee: Avure Technologies Incorporated, Kent, WA (US)

(21) Appl. No.: 11/207,582

(22) Filed: Aug. 19, 2005

(51) Int. Cl. F17C 13/06

(52) U.S. Cl. 220/582

(57) ABSTRACT

A seal assembly is provided to seal a pressure vessel and an adjacent enclosure. A metal support ring configured to contact a first sealing surface and a second sealing surface when installed in a pressure vessel, is provided with a low friction coating with transferable low friction additives which results in the transfer of a solid lubricant film onto the vessel wall enclosure. Two polymer seals are provided adjacent the metal support ring and the pressure vessel and enclosure respectively, the polymer seals having a configuration and being formed of a high resilience material, to increase the longevity of the seal assembly.

### BACKGROUND OF THE INVENTION

1. Field of the Invention

The present invention relates to fluid seals, and more particularly, to devices and systems for sealing fluids at very high pressures.

2. Description of the Related Art

Sealing fluids at extremely high pressures, i.e., pressures in excess of 15,000 psi, and even greater pressures, e.g., up to and beyond 75,000 psi, can be extremely difficult. While at low pressures of a few hundred psi, many polymers have the strength to bridge gaps up to many millimeters. However, high-pressure systems, for example high-pressure vessels, are difficult to seal because the tremendous pressures acting on a polymer seal tend to extrude the seal. Thus, it is necessary in high-pressure environments to have tight clearances between any support for a polymer seal and the sealing surface. Furthermore, high-pressure vessels that are large in diameter are even more difficult to seal, given that pressurization causes the expansion of the vessel, thereby widening any existing gap through which the seal may attempt to extrude. Given that there is appreciable movement of the seal and support ring in both a radial and axial direction as a result of the expansion of the vessel, it is necessary for the seal and support ring to remain in contact with the sealing surface during these movements in order to successfully seal a high-pressure vessel.

In a conventional high-pressure vessel, a plug or end closure is engaged with the vessel, the vessel typically having a cylindrical wall defining a circular mouth or opening. Sealing between the end closure and vessel wall is accomplished through the use of one or more polymer seals, supported by a metal ring. The seal support ring is typically constructed from a high-strength alloy in order for it to bridge a large gap between the closure and the vessel wall. Upon pressurization, the support ring is also pressurized so as to expand the ring to remain in constant contact with the pressure vessel wall. The polymer seals bridge any gaps which remain between the vessel wall, support ring, and closure.

As discussed above, the vessel and closure expand and move relative to each other as the pressure in the vessel cycles. During pressure cycles, movement of the metal ring and seal, combined with interface frictional forces, cause wear and degradation of both the support ring and polymer seals, leading to the failure of the seal assembly. The expansion and movement of the vessel components and seal assembly resulting in relative movement between the metallic support ring and the vessel wall, also causes galling and or scratching of the vessel wall, which ultimately results in seal failure. Previous attempts have been made to solve this problem by applying a hard coating to the metal support ring, however, such attempts have been unsuccessful.

### BRIEF SUMMARY OF THE INVENTION

The present invention is directed towards seals and seal systems for use with high-pressure fluid containment systems, such as ultrahigh-pressure cylinders. Embodiments of the invention allow a plug or other closure to be selectively engaged and disengaged from a pressure vessel, while effecting a fluid seal at high pressures. Embodiments of the invention improve the integrity of the seal assembly as compared to prior art sealing systems, thereby improving the quality and longevity of the seal.

In one embodiment of the present invention, a seal assembly for a pressure vessel includes a metal support ring configured to contact a first sealing surface, for example a wall of the pressure vessel, and a second sealing surface, for example an inner surface of an enclosure, when the seal assembly is installed in a pressure vessel. A first polymer seal is positionable between the metal support ring and the first sealing surface, and a second polymer seal is positionable between the metal support ring and the second sealing surface. Contrary to the prior art wherein a hard coating has been provided on the metal support ring, in accordance with the present invention, a low friction coating is provided on the metal support ring, thereby reducing frictional wear on the support ring and the polymer seals. In one embodiment, the low friction coating has transferable low friction characteristics, for example by including low friction particulates. Therefore, in accordance with the present invention, the metal support ring may include a low friction coating alone, such as a carbon based coating, or an electroless nickel coating, or it may include a low friction coating such as electroless nickel combined with a low friction particulate such as Teflon® (PTFE), boron-nitrite, or graphite.

To further improve the longevity of the seal assembly, in one embodiment, the first polymer seal has a substantially square or rectangular cross-section, and is provided with a first annular edge, a second annular edge and a groove therebetween, the first and second annular edges being configured to seat against the first sealing surface when the first polymer seal is installed in the pressure vessel. As the pressure vessel cycles through increases and decreases of pressure, the first annular edge of the polymer seal acts as a wiper, pushing away debris from the second annular edge that functions as a sealing surface. By eliminating debris adjacent the sealing surface, damage to the polymer seal and support ring is minimized, thereby improving the longevity of the seal assembly.

### BRIEF DESCRIPTION OF THE SEVERAL VIEWS OF THE DRAWINGS

FIG. 1 is a cross-sectional view of a seal assembly provided in accordance with the position, shown positioned within a pressure vessel.

FIG. 2 is a cross-sectional elevational view of one of the polymer seals of the seal assembly shown in FIG. 1.

### DETAILED DESCRIPTION OF THE INVENTION

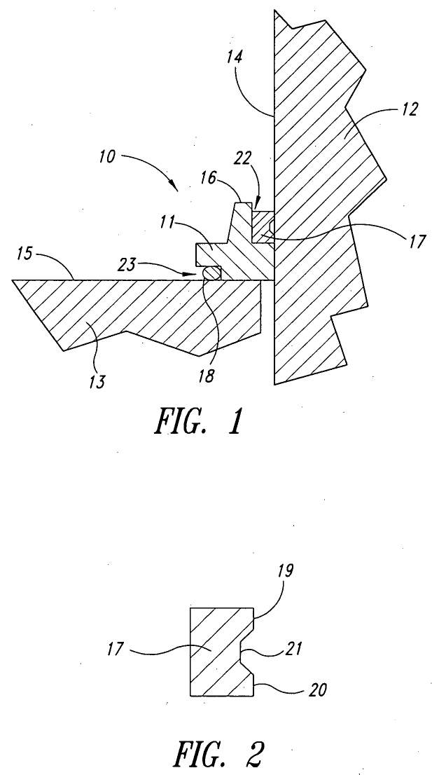

The present invention is directed toward seals in sealing systems for high pressure fluid containment, such as high pressure vessels. In one embodiment, as illustrated in FIG. 1, a seal assembly 10 comprising a metal support ring 11, a first polymer seal 17 and a second polymer seal 18 is positioned adjacent a first sealing surface 14, such as a wall of a pressure vessel 12, and a second sealing surface 15, for example an inner surface of an enclosure 13.

As discussed previously, the vessel 12 and closure 13 expand and move relative to each other as the pressure in the vessel cycles up and down. The radial and axial expansion and movement of the vessel wall 12, closure 13 and seal assembly 10, results in relative movement between the support ring 11 and vessel wall 12. In conventional systems, this results in galling and scratching of the vessel wall 12 which in turn causes damage to the polymer seal, resulting in seal failure.

These problems are substantially avoided, in accordance with the present invention, by providing a low friction coating 16 on an outer surface of the metal support ring 11. In one embodiment, the low friction coating 16 provided on the metal support ring 11 results in a friction coefficient of less than about 0.1 against stainless steel. Examples of acceptable low friction coatings include, but are not limited to, a carbon based coating, such as any one of the family of available diamond coatings, or an electroless nickel coating. In one embodiment, the coating is further provided with an additive of low friction particulates, to have transferable low friction characteristics. Examples of acceptable additives, include, but are not limited to Teflon® (PTFE), boron-nitrite particles, and graphite.

The use of a low friction coating in accordance with the present invention has resulted in significantly improved results, as compared to prior art attempts to use hard coatings. When these hard coatings fail, the hard debris can contribute to increased damage of the mating seal surface. By minimizing galling and scratching of the vessel wall, damage to the first polymer seal 17 is reduced, thereby improving the longevity of the seal assembly 10. When the coating is provided with low friction particulates, that transfer to the vessel wall, frictional wear on the first polymer seal 17, as well as on the support ring 11, are reduced. Thus, in accordance with the present invention, a transferable low friction additive from the support ring improves the longevity of both the support ring 11 and the first polymer seal 17.

The first and second polymer seals 17, 18 are preferably made of a high resilience polymer, which allows the polymer seals to return to their unpressurized shape as pressure in the vessel decreases. In one embodiment, the seals are constructed from a polymer having rebound characteristics of greater than 40%, as measured by rebound testing ASTM test D-2632. Examples of materials having such characteristics include urethane or a urethane compound. Applicants have found, however, that high resilience polymers exhibit high friction with metals, which produces twisting and other shear motions, resulting in damage to the polymer seals. Thus, as noted above, a transferable low friction additive from the support ring reduces frictional wear on the polymer seal as well.

In one embodiment of the present invention, the life of the first polymer seal 17 is further improved by providing the seal 17 with a substantially rectangular or square cross-section which minimizes rotation or twisting of the seal. As best seen in FIG. 2, the seal 17 is provided with a first annular edge 19 and a second annular edge 20, a groove 21 being provided therebetween. The first annular edge 19 functions as a wiper, which pushes debris away from the second annular edge 20, which functions as a sealing surface. More particularly as the pressure cycles off, movement of the seal 17 against the vessel wall 12 effectively “wipes” the vessel wall in the region to be sealed, such that the second annular edge 20 is exposed to a substantially clean surface upon the repressurization of the vessel. In conventional systems, debris may be trapped by the polymer seal, which in turn may cut and destroy the polymer seal as well as damage the metal support ring 11.

In one embodiment, the metal support ring 11 provided with a low friction coating is positioned adjacent the first sealing surface 14 and the second sealing surface 15, and the first polymer seal 17 is positioned in a first region 22 of the support ring 11, while the second polymer seal 18 is positioned within a second region 23 of the support ring 11. The first polymer seal 17 is larger than the first region 22, such that as the annular seal 17 is pressed into engagement with the metal support ring 11, it is precompressed by at least 15-25%. By precompressing the seal radially, hydrostatic volumetric shrinkage that occurs under ultrahigh-pressure is accommodated, ensuring that the polymer seal 17 will still perform its sealing function when under pressure. In one embodiment, a quantity of lubricant is provided between the first polymer seal 17 and the first sealing surface 14, the groove 21 provided in the polymer seal 17 functioning to trap the lubricant and hold it in the sealing region.

In accordance with the present invention, the metal support ring 11 is made of a high strength material having a low modulus of elasticity. Applicants have found that the lower the modulus, the better the performance of the support ring 11. In one embodiment, the high strength material has a modulus of elasticity of less than about 19 million psi, and a yield strength of about 80,000 to 140,000 psi. As such, the metal support ring 11 is capable of elastically expanding to accommodate the radial expansion of the vessel during pressurization. By providing the metal support ring 11 with a low friction coating in accordance with the present embodiment, it is possible to use harder materials, such as titanium, for the body of the support ring 11, whereas the use of such materials was previously not possible. Other acceptable materials for the metal support ring 11, include, but are not limited to, Cu—Ni—Sn alloys. To avoid scratching the sealing surface, in one embodiment, the metal support ring 11 has a hardness of less than RC38.

Therefore, a seal assembly provided in accordance with the present invention seals a gap between a closure 13 and a pressure vessel 12 through use of a metal support ring 11 and two polymer seals 17, 18. In accordance with the present invention, a low friction coating 16 provided on the metal support ring 11 reduces friction of the ring as well as the seal by transferring a solid lubricant film onto the vessel wall 12 and closure 13. The use of a high resilience polymer for the polymer seals 17, 18 allows long term shape retention even after high pressure deformation, and the use of first and second annular edges 19, 20 on the first polymer seal 17 allows the swiping of debris and prevents contamination of the sealing interface. Therefore, in accordance with the present invention, seal reliability and life is improved, as compared to conventional systems.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A seal assembly for a pressure vessel comprising:
a metal support ring configured to contact a first sealing surface and a second sealing surface when installed in a pressure vessel;
a low-friction coating provided on the metal support ring;
a first polymer seal positionable between the metal support ring and the first sealing surface; and
a second polymer seal positionable between the metal support ring and the second sealing surface.

2. The seal assembly according to claim 1 wherein the low-friction coating has transferable low-friction characteristics.

3. The seal assembly according to claim 1 wherein the low-friction coating includes an additive of low-friction particulates.

4. The seal assembly according to claim 1 wherein the coating is a carbon-based coating.

5. The seal assembly according to claim 1 wherein the coating is electroless nickel.

6. The seal assembly according to claim 5 wherein the coating includes an additive selected from the group of PTFE, boron-nitrite, and graphite.

7. The seal assembly according to claim 1 wherein the low-friction coating provided on the metal support ring results in a friction coefficient of less than about 0.1 against stainless steel.

8. The seal assembly according to claim 1 wherein the metal support ring is made of a high-strength material having a low modulus of elasticity.

9. The seal assembly according to claim 8 wherein the high-strength material has a modulus of elasticity less than about 19 million psi and a yield strength of about 80,000 psi-140,000 psi.

10. The seal assembly according to claim 8 wherein the metal support ring has a hardness of less than RC38.

11. The seal assembly according to claim 1 wherein the first polymer seal has a first annular edge and a second annular edge and a groove provided therebetween, the first and second annular edges being configured to seat against the first sealing surface when the first polymer seal is installed in a pressure vessel.

12. The seal assembly according to claim 11 wherein the first polymer seal is made from a high-resilience polymer.

13. The seal assembly according to claim 12 wherein the first polymer seal is made from urethane.

14. A metal support ring for supporting a polymer seal to seal a pressure vessel comprising:
a body formed of a high-strength material having a low modulus of elasticity, the body having a first region to receive a first polymer seal and a second region to receive a second polymer seal; and
a low-friction coating provided on an external surface of the body.

15. The metal support ring according to claim 14 wherein the low-friction coating includes an additive of low-friction particulates.

16. The metal support ring according to claim 14 wherein the coating is a carbon-based coating.

17. The metal support ring according to claim 14 wherein the coating is electroless nickel.

18. The metal support ring according to claim 14 wherein the coating includes an additive selected from the group of PTFE, boron-nitrite, and graphite.

19. A method for sealing a pressure vessel comprising:
positioning a metal support ring coated with a low-friction coating adjacent a first sealing surface and a second sealing surface; and
positioning a first polymer seal in a first region of the metal support ring adjacent the first sealing surface, the polymer seal being larger than the first region to precompress the first polymer seal.

20. The method according to claim 19, further comprising:
providing a quantity of lubricant between the first polymer seal and the first sealing surface.

21. A pressure vessel comprising:
an annular wall forming a body of the pressure vessel;
a closure positionable adjacent the annular wall; and
a seal assembly coupled to the closure and to the annular wall, the seal assembly having a metal support ring adjacent the annular wall and the closure, a first polymer seal positioned between the metal support ring and the annular wall, and a second polymer seal positioned between the metal support ring and the closure, the metal support ring being coated with a low-friction coating.

22. The pressure vessel according to claim 21 wherein the low-friction coating includes an additive of low-friction particulates.

23. The pressure vessel according to claim 21 wherein the coating is a carbon-based coating.

24. The pressure vessel according to claim 21 wherein the coating is electroless nickel.

25. The pressure vessel according to claim 21 wherein the coating includes an additive selected from the group of PTFE, boron-nitrite, and graphite.

26. The pressure vessel according to claim 21 wherein the first polymer seal has a first annular edge and a second annular edge and a groove provided therebetween, the first and second annular edges being configured to seat against the annular wall.
